(19) United States
(12) Patent Application Publication
(10) Pub. No.: US 2019/0276158 A1
(43) Pub. Date: Sep. 12, 2019

(54) ACTIVE COOLING SYSTEM

(71) Applicant: Bell Helicopter Textron Inc., Forth Worth, TX (US)

(72) Inventors: Eric A. Sinusas, Euless, TX (US); Ryan Thomas Ehinger, Southlake, TX (US)

(73) Assignee: Bell Helicopter Textron Inc., Fort Worth, TX (US)

(21) Appl. No.: 15/915,642

(22) Filed: Mar. 8, 2018

(51) Int. Cl. B64D 33/08; B64D 35/02; B64D 29/00; F01M 5/00

(52) U.S. Cl. CPC B64D 33/08; B64D 35/02; B64C 29/0033; F01M 5/002; B64D 29/00

(57) ABSTRACT

An active cooling system includes a sensor configured to monitor a status of a lubrication system of a lubricated component and a cowling configured to cover at least a portion of the lubricated component. The cowling includes an inlet panel configured to move from a normal operating position to a cooling position, wherein the cooling position creates an air inlet configured to increase airflow passing by the lubricated component. The active cooling system further includes an actuator configured to initiate movement of the inlet panel from the normal operating position to the cooling position.

### BACKGROUND

A loss-of-lubrication event can cause catastrophic failure of a transmission. For example, if a transmission relies on the circulation of a lubricant to maintain lubrication at an effective operating temperature within the transmission, any failure of that circulatory system will result in increased friction, a rapidly spiking temperature, and eventually seizure of the transmission. Seizure of a transmission on an aircraft while in flight would be catastrophic. Accordingly, precautions must be taken to ensure this does not happen. For this reason, aircraft are currently equipped with backup emergency lubrication systems designed to provide enough extra life to the transmission to enable a safe landing prior to transmission seizure.

While these backup emergency lubrication systems may successfully keep the transmission operating for enough additional time to enable a safe landing, they are not without their disadvantages. For example, they are quite heavy and expensive. These backup emergency lubrication systems generally include a secondary lubricant reservoir filled with additional lubricant, a heater to maintain the additional lubricant at a functional temperature/viscosity, and a secondary pump to circulate the additional lubricant through the transmission. Moreover, these emergency lubrication systems are not fully redundant systems, and therefore, they may not prevent damage to the transmission caused by a loss-of-lubrication event. These backup systems are merely designed to sustain the use of the transmission long enough to enable a safe landing. Accordingly, there is a need for a lighter weight, less expensive, alternative system to sustain a transmission during a loss-of-lubrication event.

### BRIEF DESCRIPTION OF THE DRAWINGS

FIG. 1 is a partially transparent oblique view of an aircraft showing a drive system.

FIG. 2 is a side view of the aircraft of FIG. 1 including an active cooling system, according to this disclosure.

FIG. 3 is a side view of the aircraft of FIG. 2 with panels of the active cooling system deployed.

FIG. 4. is a side view of the aircraft of FIG. 1 with an alternative active cooling system deployed.

FIG. 5 is a partially transparent side view of a nacelle of the aircraft of FIG. 1.

FIG. 6 is an oblique view of a portion of a transmission of the aircraft of FIG. 1.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure divulges an active cooling system for a lubricated component. The active cooling system utilizes convection cooling to remove heat from the lubricated component. The convection cooling can be external or internal to the component. That is, the cooling system can actively direct airflow toward an exterior surface of a housing of the component, or, if the external convection cooling effect is insufficient, the housing of the component may be opened, and airflow directed through the interior of the component for additional cooling.

The active cooling system may, for example, serve as an emergency cooling system for a transmission on an aircraft. In that capacity, the status of a lubrication system of the component is monitored by a sensor. In the event of failure of the lubrication system, the emergency active cooling system may be activated by a pilot in response to a warning provided by the sensor, or the emergency active cooling system may be automatically activated in response to a loss-of-lubrication event. The emergency active cooling system provides emergency cooling by channeling cool air toward the transmission housing and/or into the interior of the transmission so that the cool air may absorb and carry away heat from the transmission.

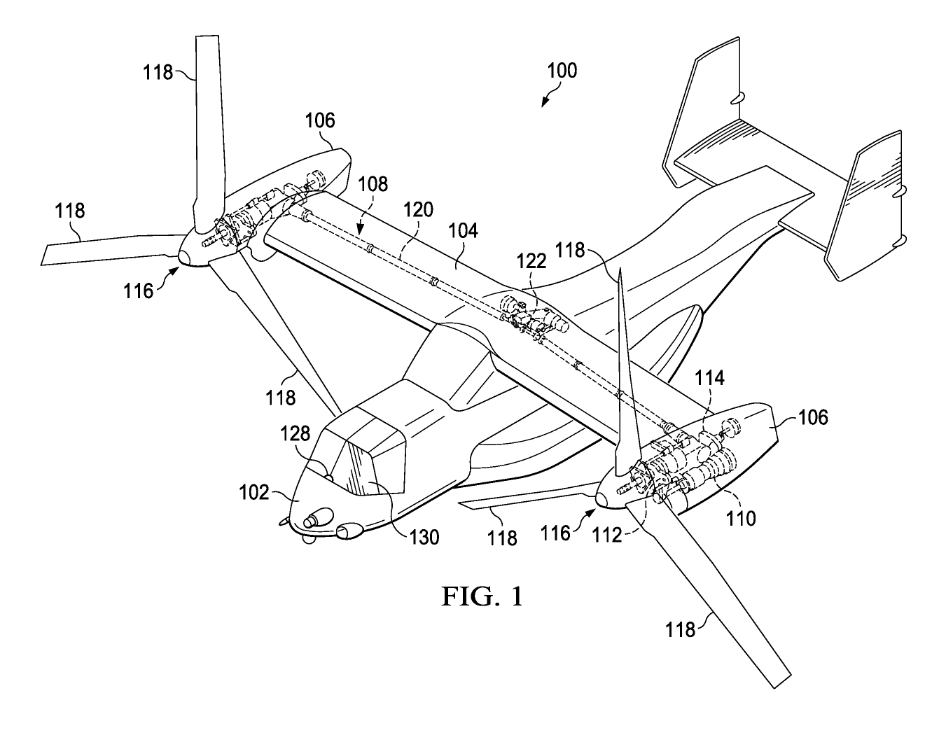

FIGS. 1-4 show an aircraft 100 including a fuselage 102 and a wing 104 extending bilaterally from fuselage 102. Coupled to opposite ends of wing 104 are a pair of nacelles 106. Nacelles 106 are rotatable between a vertical, helicopter position, and a horizontal, airplane position (nacelles 106 are shown in the airplane position in FIGS. 1-4). As shown in FIG. 1, aircraft 100 includes a drive system 108 extending from nacelles 106 through wing 104. The portion of drive system 108 within each nacelle 106 includes an engine 110, a proprotor transmission 112, and a tilt-axis transmission 114. Engine 110 is configured to provide rotational energy to proprotor transmission 112, which in turn, provides rotational energy to a proprotor 116. Rotation of blades 118 of proprotor 116 creates thrust when nacelle 106 is in the airplane position and lift when nacelle 106 is in the helicopter position. Rotation of nacelles 106 between the airplane position and the helicopter position is facilitated by rotational energy provided by engine 110 to tilt-axis transmission 114, whereby tilt-axis transmission 114 affects rotation of nacelle 106. Drive system 108 provides redundant drive capabilities so that either engine 110 may provide rotational energy to both proprotor transmissions 112 and both tilt-axis transmissions 114. This redundancy is facilitated by driveshafts 120 extending from nacelles 106 through wing 104 and coupled to a mid-wing transmission 122. Each of engine 110, proprotor transmission 112, tilt-axis transmission 114, and mid-wing transmission 122 are lubricated components. As such, each of these lubricated components includes a primary lubrication system that circulates oil through the component to maintain the oil within a safe operating temperature range. Each of these lubricated components may be equipped with an emergency active cooling system. While an active cooling system 124 is described below in conjunction with proprotor transmission 112, it should be understood that a similar active cooling system may be used in conjunction with engine 110, tilt-axis transmission 114, and/or mid-wing transmission 122.

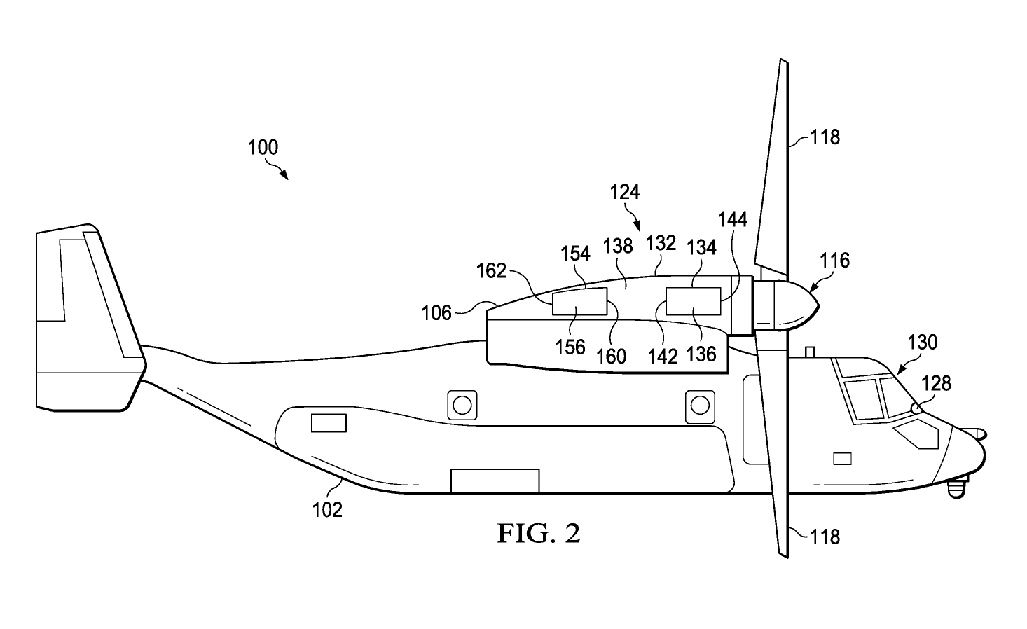

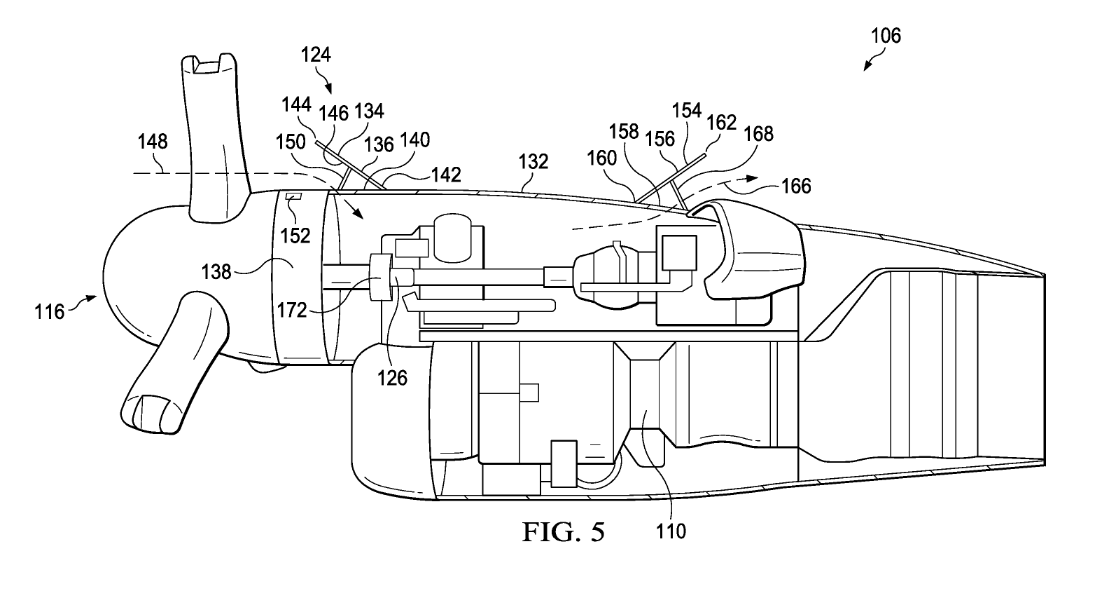

As shown in FIGS. 2-6, the primary lubrication system of proprotor transmission 112 is backed up by active cooling system 124. Active cooling system 124 includes a sensor 126 configured to monitor the operational status of the primary lubrication system. Depending on the type of primary lubrication system, sensor 126 can measure different metrics to determine the occurrence of a loss-of-lubrication event. For example, a pressurized oil circulation system may be deemed to have a loss-of-lubrication event if the oil pressure drops to zero, whereas a splash lubrication system may be deemed to have a loss-of-lubrication if the oil temperature reaches a maximum temperature or the level of oil in the reservoir falls below a certain level. Sensor 126 may be configured to display the status of the primary lubrication system to a pilot of aircraft 100, including an indicator 128, located within a cockpit 130, that signals that a loss-of-lubrication event has occurred. In response, the pilot may engage active cooling system 124. Alternatively, active cooling system 124 may be configured to automatically engage if a predetermined output of sensor 126 occurs.

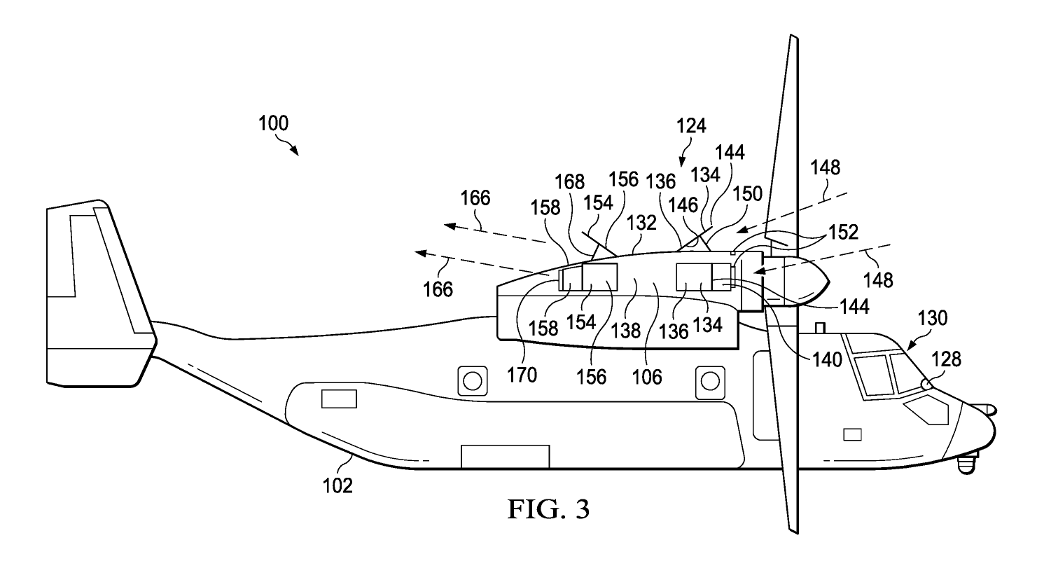

Active cooling system 124 includes a cowling 132 covering proprotor transmission 112. Cowling 132 is configured to protect proprotor transmission 112 from the elements as well as increase the aerodynamic efficiency of aircraft 100. Cowling 132 includes one or more inlet panels 134 that are configured to move from a normal operating position (shown in FIG. 2) to a cooling position (shown in FIG. 3). In the normal operating position, an outer surface 136 of inlet panel 134 is substantially flush with an outer surface 138 of cowling 132. Movement of inlet panel 134 to the cooling position creates a cowling air inlet 140. The cooling position of inlet panel 134 may be any one of several different possible positions, all of which are configured to increase airflow through cowling air inlet 140 to proprotor transmission 112. For example, inlet panel 134 may include a trailing end 142 that is hinged, and an opposite leading end 144 configured to rotate away from outer surface 138 of cowling 132, such that an internal surface 146 of inlet panel 134 directs cool air 148 through cowling air inlet 140 toward proprotor transmission 112. Inlet panel 134 may be maintained in this cooling position by a pair of arms 150 connecting inlet panel 134 to cowling 132. Alternatively, the cooling position of inlet panel 134 may include inlet panel 134 being hinged at leading end 144 and trailing end 142 being configured to rotate inwards. Alternatively, the cooling position of inlet panel 134 may also include inlet panel 134 being jettisoned from aircraft 100 to create cowling air inlet 140. When aircraft 100 is in airplane mode, the forward flight of aircraft 100, along with the air pushed rearward by rotating blades 118, forces cool air 148 into cowling air inlet 140. When aircraft 100 is in helicopter mode, rotation of blades 118 drives cool air 148 downward and into cowling air inlet 140. Accordingly, more air is driven into cowling air inlet 140 in airplane mode than in helicopter mode. In addition, less energy passing through proprotor transmission 112 is required in airplane mode than in helicopter mode, and therefore, less heat may be generated in airplane mode. Therefore, during use of the active cooling system 124, it may be preferable to transition aircraft 100 from helicopter mode to airplane mode in order to maximize convection cooling of proprotor transmission 112.

Movement of inlet panel 134 from the normal operating position to the cooling position is initiated by an actuator 152. Inlet panel 134 may be biased toward the cooling position and actuator 152 retains inlet panel 134 in the normal operating position until actuator 152 is activated. Inlet panel 134 may be biased open by springs or pneumatic or hydraulic cylinders, for example, arms 150 may be cylinders biasing inlet panel 134 towards the open, cooling position. Actuator 152 may comprise a latch configured to release inlet panel 134 to the biased cooling position. The latch may be an electrical, mechanical, hydraulic, or pneumatic mechanism. The latch may also be an electromagnet wherein loss of current releases inlet panel 134. The latch may also be a memory metal configured to change shape if it reaches a predetermined temperature, wherein the shape change releases inlet panel 134. In this configuration, the memory metal may act as sensor 126 monitoring the temperature and actuator 152 initiating the movement of inlet panel 134. Similarly, actuator 152 may be a thermoplastic component configured to deform beyond a maximum temperature, whereby the deformation releases inlet panel 134. Actuator 152 may also be a pyrotechnic fastener, or explosive bolt, configured to release the biasing force or to act as a jettisoning force. Alternatively, inlet panel 134 may not be biased open. Instead, actuator 152 may comprise an electrical, mechanical, hydraulic, or pneumatic cylinder that does not exert a force until it is activated, and when actuator 152 is activated, it pushes or pulls, inlet panel 134 open.

Cowling 132 may further include one or more outlet panels 154 that are configured to move from a normal operating position (shown in FIG. 2) to a cooling position (shown in FIG. 3). In the normal operating position, an outer surface 156 of outlet panel 154 is substantially flush with outer surface 138 of cowling 132. Movement of outlet panel 154 to the cooling position creates a cowling air outlet 158. The cooling position of outlet panel 154 may be any one of several different possible positions, all of which are configured to increase airflow passing by proprotor transmission 112 and out of cowling air outlet 158. For example, outlet panel 154 may include a leading end 160 that is hinged and an opposite trailing end 162 configured to rotate away from cowling 132. Alternatively, the cooling position of outlet panel 154 may include outlet panel 154 being hinged on trailing end 162 and configured to rotate inwards such that outer surface 156 of outlet panel 154 directs hot air 166 away from proprotor transmission 112 and out of cowling air outlet 158. Outlet panel 154 may be maintained in the cooling position by a pair of arms 168 connecting outlet panel 154 to cowling 132. In yet another alternative, the cooling position may comprise outlet panel 154 being jettisoned from aircraft 100 to create cowling air outlet 158.

Movement of outlet panel 154 from the normal operating position to the cooling position may be initiated by an actuator 170. Outlet panel 154 may be biased toward the cooling position and actuator 170 retains outlet panel 154 in the normal operating position until actuator 170 is activated. Outlet panel 154 may be biased open by springs or pneumatic or hydraulic cylinders, for example, arms 168 may be cylinders biasing outlet panel 154 towards the open, cooling position. Actuator 170 may comprise a latch configured to release outlet panel 154 to the biased cooling position. The latch may be an electrical, mechanical, hydraulic, or pneumatic mechanism. The latch may also be an electromagnet wherein loss of current releases outlet panel 154. The latch may also be a memory metal configured to change shape if it reaches a predetermined temperature, wherein the change in shape releases outlet panel 154. In this configuration, the memory metal may act as sensor 126 monitoring the temperature and actuator 170 initiating the movement of outlet panel 154. Similarly, actuator 170 may be a thermoplastic component configured to deform beyond a maximum temperature, whereby the deformation releases outlet panel 154. Actuator 170 may also be a pyrotechnic fastener, or explosive bolt, configured to release the biasing force or to act as the jettisoning force. Alternatively, outlet panel 154 may not be biased open. Instead, actuator 170 may comprise an electrical, mechanical, hydraulic, or pneumatic cylinder that does not exert a force until it is activated, and when actuator 170 is activated, it pushes or pulls, outlet panel 154 open.

External convection cooling of proprotor transmission 112 is accomplished by cool air 148 entering through cowling air inlet 140 and contacting a housing 172 of proprotor transmission 112, heat is then transferred to cool air 148, thereby heating cool air 148 to hot air 166, and then hot air 166 exits through cowling air outlet 158. In order to maximize the heat transfer from housing 172 to cold air 148, housing 172 may include one or more fins 174 extending therefrom to increase the surface area of housing 172. In addition, active cooling system 124 may include ducts within cowling 132 that direct cold air 148 from cowling air inlet 140 directly at optimal portions of housing 172.

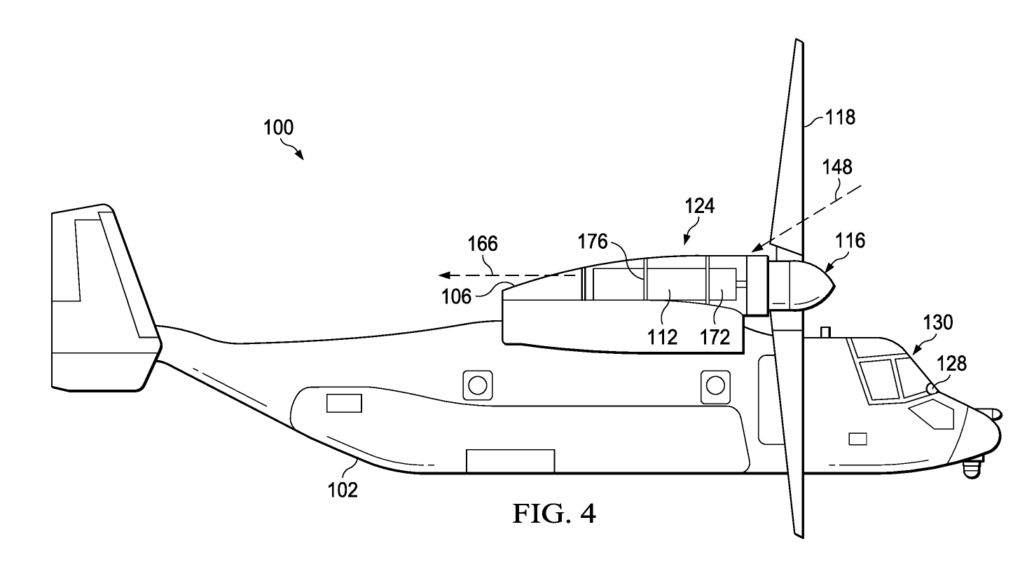

FIG. 4 shows an alternative embodiment wherein inlet panel 134 of cowling 132 includes substantially the entire cowling 132. In this embodiment, movement of inlet panel 134 to the cooling position constitutes releasing substantially the entire cowling 132 from an airframe 176 and jettisoning it so that proprotor transmission 112 is completely exposed to the surrounding air.

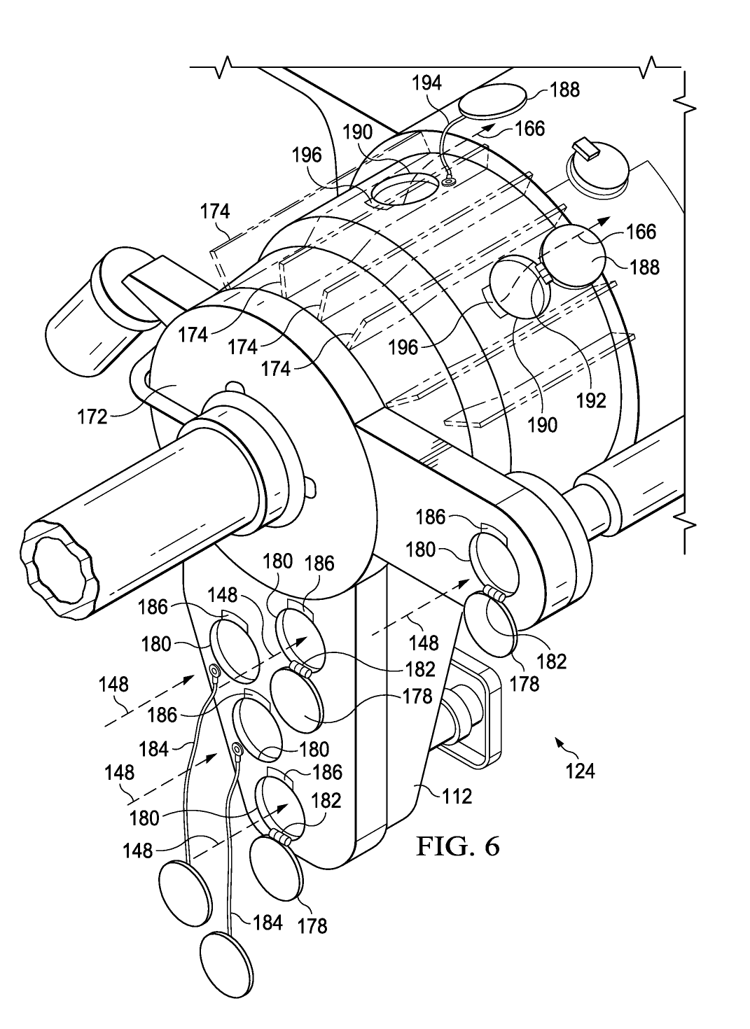

The external convection cooling of proprotor transmission 112 may not provide enough cooling to prevent seizure. As such, as shown in FIG. 6, active cooling system 124 may also include internal convection cooling of proprotor transmission 112. The internal convection cooling of proprotor transmission 112 is accomplished by directing cold air 148 directly into the interior of proprotor transmission 112, where cool air 148 absorbs heat, thereby creating hot air 166, and then hot air 166 exits proprotor transmission 112. The internal convection cooling may be triggered by the same sensor 126 as described above.

Airflow through the interior of proprotor transmission 112 is created in a similar manner to how airflow through the interior of cowling 132 is created. Housing 172 includes one or more inlet covers 178 that are configured to move from a closed position, wherein the interior of proprotor transmission 112 is sealed off from the outside environment, to an open position, wherein the interior of proprotor transmission 112 is in communication with the outside air. Movement of inlet cover 178 to the open position creates a housing air inlet 180. The open position of inlet cover 178 may be any one of several different possible positions, all of which are configured to increase airflow through housing air inlet 180. For example, inlet cover 178 may include a hinge 182 configured to facilitate rotation of inlet cover 178 away from housing 172. Alternatively, the open position of inlet cover 178 may include inlet cover 178 being jettisoned from aircraft 100 to create housing air inlet 180. In yet another alternative, inlet cover 178 may be attached by a tether 184 coupled to housing 172. In yet another alternative, inlet cover 178 may be made of a thermoplastic material configured to melt when the temperature exceeds a predetermined maximum.

Movement of inlet cover 178 from the closed position to the open position is initiated by an actuator 186. Inlet cover 178 may be biased toward the open position and actuator 186 retains inlet cover 178 in the closed position until actuator 186 is activated. Inlet cover 178 may be biased open by springs or pneumatic or hydraulic cylinders. Actuator 186 may comprise a latch configured to release inlet cover 178 to the biased open position. The latch may be an electrical, mechanical, hydraulic, or pneumatic mechanism. The latch may also be an electromagnet wherein loss of current releases inlet cover 178. The latch may also be a memory metal configured to change shape if it reaches a predetermined temperature, wherein the shape change releases inlet cover 178. In this configuration, the memory metal may act as sensor 126 monitoring the temperature and actuator 186 initiating the movement of inlet cover 178. Similarly, actuator 186 may be a thermoplastic component configured to deform beyond a maximum temperature, whereby the deformation releases inlet cover 178. Actuator 186 may also be a pyrotechnic fastener, or explosive bolt, configured to release the biasing force or to act as the jettisoning force. Alternatively, inlet cover 178 may not be biased open. Instead, actuator 186 may comprise an electrical, mechanical, hydraulic, or pneumatic cylinder that does not exert a force until it is activated, and when actuator 186 is actuated, it pushes or pulls, inlet cover 178 open.

Housing 172 may further include one or more outlet covers 188 that are configured to move from a closed position to an open position. Movement of outlet cover 188 to the open position creates a housing air outlet 190. The open position of outlet cover 188 may be any one of several different possible positions, all of which are configured to increase airflow out of housing 172 through housing air outlet 190. For example, outlet cover 188 may include a hinge 192 configured to facilitate rotation of outlet cover 188 away from housing 172. Alternatively, the open position of outlet cover 188 may include outlet cover 188 being jettisoned from aircraft 100 to create housing air outlet 190. In another alternative, outlet cover 188 may be attached by a tether 194 coupled to housing 172. In yet another embodiment, outlet cover 188 may be made of a thermoplastic material configured to melt when the temperature exceeds a predetermined maximum.

Movement of outlet cover 188 from the closed position to the open position is initiated by an actuator 196. Outlet cover 188 may be biased toward the open position and actuator 196 retains outlet cover 188 in the closed position until actuator 196 is activated. Outlet cover 188 may be biased open by springs or pneumatic or hydraulic cylinders. Actuator 196 may comprise a latch configured to release outlet cover 188 to the biased open position. The latch may be an electrical, mechanical, hydraulic, or pneumatic mechanism. The latch may also be an electromagnet wherein loss of current releases outlet cover 188. The latch may also be a memory metal configured to change shape if it reaches a predetermined temperature, wherein the shape change releases outlet cover 188. In this configuration, the memory metal may act as sensor 126 monitoring the temperature and actuator 196 initiating the movement of outlet cover 188. Similarly, actuator 196 may be a thermoplastic component configured to deform beyond a maximum temperature, whereby the deformation releases outlet cover 188. Actuator 196 may also be a pyrotechnic fastener, or explosive bolt, configured to release the biasing force or to act as the jettisoning force. Alternatively, outlet cover 188 may not be biased open. Instead, actuator 196 may comprise an electrical, mechanical, hydraulic, or pneumatic cylinder that does not exert a force until it is activated, and when actuator 196 is activated, it pushes or pulls, outlet cover 188 open.

It should be understood that inlet covers 178 and outlet covers 188 may be existing access or observation covers of proprotor transmission 112 that have been modified to facilitate the internal convection cooling. Possible additional components of active cooling system 124 may include: fans directing airflow at housing 172 or into housing air inlet 180, compressed gases configured to be released through a nozzle directed at housing 172 or into housing air inlet 180, or a misting system configured to spray a mist or stream of water, or other suitable liquid, on housing 172 to cause evaporative cooling.

While active cooling system 124 is shown and discussed for use with, tiltrotor aircraft 100, active cooling system 124 could be used on any aircraft. As such, the claims appended hereto should not be interpreted as limiting the active cooling system to use on a particular aircraft type unless specifically stated therein. Moreover, while active cooling system 124 is described in conjunction with proprotor transmission 112, it may be used for cooling any aircraft component that may benefit from additional cooling. For example, active cooling system 124 may be used with engine 110, tilt-axis transmission 114, and/or mid-wing transmission 122.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A cooling system, comprising:
a cowling configured to cover at least a portion of the lubricated component, the cowling including an inlet panel configured to move from a normal operating position to a cooling position, wherein the cooling position creates a cowling air inlet configured to increase airflow to a lubricated component; and
an actuator configured to initiate movement of the inlet panel from the normal operating position to the cooling position, the actuator being configured to respond to an output of a sensor or an input of a user.

2. The cooling system of claim 1, wherein the cooling position of the inlet panel includes the inlet panel being jettisoned.

3. The cooling system of claim 1, wherein the actuator is configured to automatically respond to a predetermined output of the sensor.

4. The cooling system of claim 1, wherein the cooling position of the inlet panel includes having a leading end configured to rotate away from the cowling and an internal surface of the inlet panel configured to direct airflow through the cowling air inlet towards the lubricated component.

5. The cooling system of claim 4, wherein the cowling further includes an outlet panel configured to move from a normal operating position to a cooling position, wherein the cooling position creates a cowling air outlet configured to channel air out of the cowling.

6. The cooling system of claim 5, further comprising:
a duct configured to channel air from the cowling air inlet toward a housing of the lubricated component.

7. The cooling system of claim 5, further comprising:
a plurality of fins extending from a housing of the lubricated component, the plurality of fins configured to intersect airflow between the cowling air inlet and the cowling air outlet.

8. The cooling system of claim 1, further comprising:
an inlet cover coupled to a housing of the lubricated component, the inlet cover being configured to move from a sealed position, wherein an interior of the lubricated component is closed to the air, to an open position, wherein the interior of the lubricated component is open to the air.

9. A cooling system, comprising:
an inlet cover coupled to a housing of a lubricated component, the inlet cover being configured to move from a closed position, wherein an interior of the lubricated component is a closed to the air, to an open position, wherein the interior of the lubricated component is open to the air, creating a housing air inlet;
a sensor configured to monitor a status of a lubrication system of a lubricated component; and
an actuator configured to initiate movement of the inlet cover from the closed position to the open position.

10. The cooling system of claim 9, further comprising:
an outlet cover coupled to the housing of the lubricated component, the outlet cover being configured to move from a closed position, wherein an interior of the lubricated component is closed to the outside, to an open position, wherein the interior of the lubricated component is open to the air, creating a housing air outlet, the inlet cover and the outlet cover being positioned so that when the inlet cover and the outlet cover are both in the open position air flows in the housing air inlet and out the housing air outlet.

11. The cooling system of claim 9, wherein the sensor is configured to provide a display to an operator and the actuator is configured to be activated by the operator.

12. The cooling system of claim 11, wherein activation of the actuator is an automated response to a predetermined output of the sensor.

13. The cooling system of claim 10, further comprising:
a cowling configured to cover at least a portion of the lubricated component, the cowling including an inlet panel configured to move from a normal operating position to a cooling position, wherein the cooling position creates a cowling air inlet configured to increase airflow into the cowling; and
an actuator configured to initiate movement of the inlet panel from the normal operating position to the cooling position.

14. The cooling system of claim 13, wherein the cowling air inlet is configured to direct airflow into the housing air inlet.

15. The cooling system of claim 14, wherein the cowling further includes an outlet panel configured to move from a normal operating position to a cooling position, wherein the cooling position creates a cowling air outlet configured to channel air from the housing air outlet out of the cowling.

16. An aircraft, comprising:
a fuselage;
a powerplant;
a transmission;
a cooling system, comprising:
a sensor configured to monitor a status of a lubrication system of the transmission;
a cowling configured to cover at least a portion of the transmission, the cowling including an inlet panel configured to move from a normal operating position to a cooling position, wherein the cooling position creates a cowling air inlet configured to increase airflow passing by the transmission; and
an actuator configured to initiate movement of the inlet panel from the normal operating position to the cooling position.

17. The aircraft of claim 16, further comprising:
an inlet cover coupled to a housing of the transmission, the inlet cover being configured to move from a sealed position, wherein an interior of the transmission is closed to the air, to an open position, wherein the interior of the transmission is open to the air.

18. The aircraft of claim 17, further comprising:
an outlet cover coupled to the housing of the transmission, the outlet cover being configured to move from a closed position to an open position, creating a housing air outlet, the inlet cover and the outlet cover being positioned so that when the inlet cover and the outlet cover are both in the open position air flows in the housing air inlet and out the housing air outlet.

19. The aircraft of claim 18, wherein the cowling further includes an outlet panel configured to move from a normal operating position to a cooling position, wherein the cooling position creates a cowling air outlet configured to channel air from the housing air outlet out of the cowling.

20. The aircraft of claim 19, wherein the sensor is configured to provide a display to an operator and the actuator is configured to be activated by the operator.
